(19) United States
(12) Patent Application Publication
(10) Pub. No.: US 2009/0104434 A1
(43) Pub. Date: Apr. 23, 2009

(54) CONFORMAL MULTIFUNCTIONAL COATINGS

(76) Inventor: Jennifer Hoyt Lalli, Blacksburg, VA (US)

Correspondence Address: SHERR & VAUGHN, PLLC, 620 HERNDON PARKWAY, SUITE 200, HERNDON, VA, 20170, US

(21) Appl. No.: 12/253,314

(22) Filed: Oct. 17, 2008

Related U.S. Application Data
(60) Provisional application No. 60/980,754, filed on Oct. 17, 2007.

(51) Int. Cl. B32B 5/16

(52) U.S. Cl. 428/323

(57) ABSTRACT

A device includes a substrate having an outer surface and a nano-particle coating on the outer surface. In particular, the nano-particle coating is substantially a molecular monolayer of a plurality of nano-particles. Furthermore, a composite material may be constructed that includes a base material having one or more ingredients and a filler material. In particular, the filler material is made up of a plurality of particulates which, themselves, include a substrate having an outer surface and a nano-particle coating on the outer surface.

The present application claims priority to U.S. Provisional Patent Application No. 60/980,754 (filed Oct. 17, 2007) which is hereby incorporated by reference in its entirety.

### BACKGROUND

Coatings that are used to manipulate the surface or bulk properties of nano- or micro-structured substrates (particles, fillers or irregularly shaped materials) are generally applied to the substrate by methods such as vacuum deposition, magnetron sputtering and other costly methods. These coating methods have a disadvantage in that they may not be capable of producing a conformal molecular monolayer of the desired material onto substrates having curved surfaces and/or into the cavities of substrates having highly irregular surface structures.

### SUMMARY

Embodiments relate a device that includes a substrate having an outer surface and a nano-particle coating on the outer surface. In particular, the nano-particle coating is substantially a molecular monolayer of a plurality of nano-particles.

In accordance with embodiments, a composite material is constructed that includes a base material having one or more ingredients and a filler material. In particular, the filler material is made up of a plurality of particulates which, themselves, include a substrate having an outer surface and a nano-particle coating on the outer surface.

Embodiments relate to a method of formulating a composite material that includes combining a base material including one or more ingredients and a filler material; wherein the filler material includes a plurality of particulates each having a substrate having an outer surface and a nano-particle coating on the outer surface.

### DRAWINGS

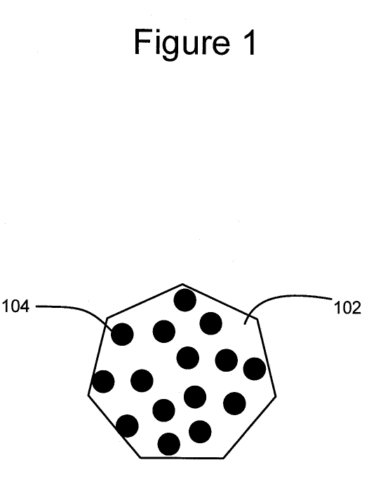

Example FIG. 1 illustrates a filler with a conformal coating of nano-particles, in accordance with embodiments.

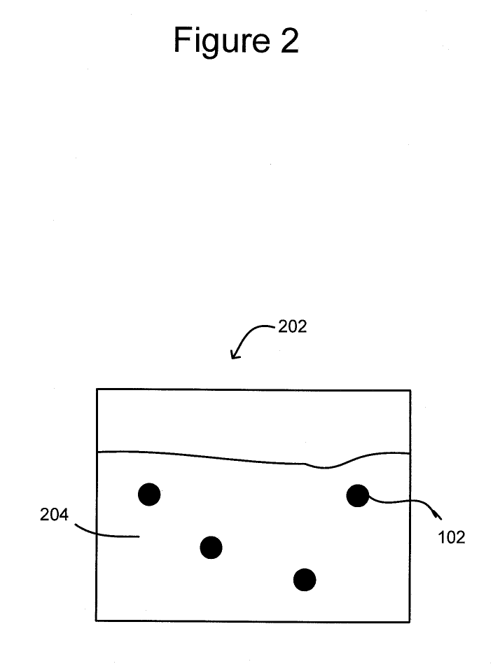

Example FIG. 2 illustrates a composite material that includes nano-particle coatings, in accordance with embodiments.

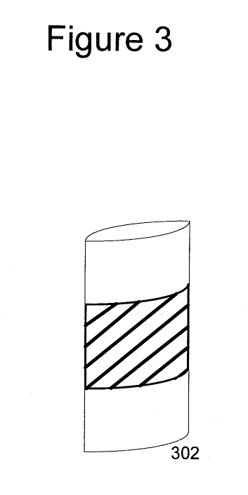

Example FIG. 3 illustrates an arbitrary shaped substrate with a nano-particle coating, in accordance with embodiments.

### DESCRIPTION

In accordance with embodiments, methodologies are provided for the formation of nano-particle coatings which conform to the surface of a substrate by the controlled growth of nano-particle monolayers or nano-particles multilayers using aqueous solutions comprising a metal and a reducing solution. These methods may be used to form coatings on substrates of arbitrary material type, size and shape. The coating may confer specific properties onto the substrate including electrical and thermal conductivity, magnetic permeability, optical/electromagnetic permittivity, mechanical modulus, abrasion resistance and hardness, nonlinear optical properties, piezoelectric and electrostrictive properties, radiopacity, chemical affinity, biocompatibility, color, and sheen may be controlled via the incorporated nano-particles and any resulting nano-clusters.

Example FIG. 1 illustrates a filler with a conformal coating of nano-particles, in accordance with embodiments. In example FIG. 1, a filler 102 of a relatively light or inexpensive material may serve as a substrate for a conformal coating 104 of nano-particles of some other bulk material. In accordance with embodiments, a molecular, substantially-monolayer coating is formed evenly around substantially the entire outside surface of the filler 102. Multiple such layers may also be formed. As a result, the conformal-coated filler 102, once coated, provides many of the properties of the bulk material without the weight of expense of providing similarly sized solid particles of the bulk material.

Example FIG. 2 illustrates a composite material that includes nano-particle coatings, in accordance with embodiments. In example FIG. 2, a composite material 202 is formulated which includes the conformal coated filler 102 at a desired density or percentage substantially evenly dispersed throughout the material 202. The composite material 202 may, for example, be cosmetics, paints, adhesives and other similar materials. Thus, the composite material 202 includes its conventional product ingredients 204 but also includes an appropriate amount of conformal-coated filler 102. Thus, the composite material 202 behaves substantially as intended but is enhanced, as discussed below, by the addition of the coated filler 102.

Example FIG. 3 illustrates an arbitrary shaped substrate with a nano-particle coating, in accordance with embodiments. In addition to conformal coating small particulate filler material, nano-particles may be used to conformal coat large, odd-shaped substrates that have pits or crevices sized similarly to the nano-particles. Such as, for example, a medical stent 302. The stent may be coated with nano-particles that increase its radiopacity from almost every orientation but are too small to affect the stent's physical size, movement capability, and operation. In this way, irregular-shaped substrates with uneven surfaces may be coated with one or more molecular, substantially-monolayer coatings.

In accordance with embodiments, monolayer nano-particle coatings or multilayer nano-particle coatings may be formed by first immersing a substrate into a nano-particle growth solution. The nano-particle growth solution may contain at least one nano-particle species and a reducing agent which corresponds to the particular species of nano-particle being used. The reducing agent reduces the metal onto the surface of the substrate. Using this methodology, coating thickness and the resulting properties of the coating such as conductivity and reflectance may be controlled by varying the starting material amounts, relative concentrations of the components in the solutions, and the immersion time.

The substrate may include, but is not limited to, items such as a glass slide, single crystal silicon, polycarbonate, kapton, polyethylene rigid polymer materials, flexible polymer materials, ceramics, metal surfaces, etched surfaces, and any filler such as mica or resembles a bulk metal or other high-cost materials that may be used in cosmetics, paint, biomedical systems, adhesives, and other commercial applications. Moreover, the substrate may be an irregularly-shaped, relatively-large substrate with micron- or nano-sized cavities that require coating or modification, such as a coronary stent, for example. The chemical functionality of the substrate may control the extent of the surface modification.

An early step, according to embodiments, may comprise cleaning the substrate surface prior to any chemical functionalization or surface modification in order to optimize the visual appearance or bulk properties of the resultant coated substrate. Since most polar substrates have some amount of both physioabsorbed (i.e., physically attached) and chemiabsorbed (i.e., covalently attached) water associated with the surface, the substrate may have to be dehydrated prior to cleaning to remove all of the physioabsorbed water. In particular, it is beneficial to remove substantially all of the physioabsorbed water from substrates having irregular structures and cavities. The dehydration process may be performed, for example, by heating the substrate in a vacuum oven for a time period greater than about 1 hour at a temperature of greater than about 100° C. The oven should be allowed to equilibrate to room temperature prior to removing the vacuum.

Following the dehydration process, the substrate may then be cleaned in order to increase the surface wettability towards the solvent and reagents intended for use during the coating process. The cleaning process may be performed by immersion or sonication, such as ultrasonic sonication, of the substrate into a solution containing a solvent having a polarity that corresponds to the substrate. Subsequently, the substrate may then be immersed or sonicated in successive solutions having solvents that match the polarity of the solutions containing the adherents to be coated onto the substrate. Also, certain substrates may not require cleaning prior to the coating process of the invention.

Alternatively, if a greater level of surface functionalization is required, acidic etches may be used. This process is similar to the cleaning process described above, but further involves the use of an appropriate acid etch. The acid etching solution may be a HF solution, a H₂SO₄ solution, a HCl solution, a HNO₃ solution, a H₃PO solution or a solution having a mixture thereof. For example, coronary stents fabricated from stainless steel or other metals, may be subjected to acid etching prior to chemical surface modification. Moreover, plasma cleaning may be used for materials susceptible to chemical degradation via chemical and acid etch processes.

In accordance with embodiments, substrates may be chemically functionalized after the cleaning process. The substrates may be functionalized when a chemical functionality other than hydroxyl groups is desired or if a controlled amount of hydroxyl groups are required. For example, clean substrates having a controlled amount of hydroxyl functionality may be chemically functionalized by using a reagent, such as a silane or other reagents capable of reacting with hydroxyl groups. Sol-gel chemistry, for example, and a unique order of adding silanes may be used for clean substrates of the invention.

While the chemical functionalization of the cleaned substrates may be controlled by using silanes, the functionalization process is not limited to reactions with only hydroxyl groups. Thus, any reagent that reacts with a hydroxyl group may be used in this process. For example, certain nanostructured metals may involve the thiol functionalization of fillers or substrates. This process may involve the immersion of the substrate into a toluene solution (or another suitable solvent) followed by the addition of varied volume fractions of 3-mercaptopropyltriethoxysilane (3-MPS) at varied times and temperatures. Alternatively, for filler modification, this process may be followed by soxhlet extraction with a suitable solvent such as ethanol. Finally, the functionalized substrate may be cured and/or dehydrated in a vacuum oven at varied times and temperatures. X-Ray Photoelectron Spectroscopy (XPS) may be used to determine the percentage of chemical functionalization, if desired. In general, following functionalization, thiol groups at the surface of the substrate may be present in an amount in the range of about 1% to about 10%. Additionally, certain substrates may not require chemical functionalization prior to subsequent coating processes.

Example processes are described below with specific steps and components. However, the process for producing conformal thin (nm) films, as well as films with a broad range of physical properties (optical, mechanical, magnetic, thermal, and electrical) may vary based on the type of nano-particle species incorporated onto the filler or substrate. Sequential processing combined with optimized conditions allow for controlled conductivity, uniformity, reflectance, and for repeatability between fabricated samples.

Conformal coatings applied to a desired substrate may alter 1) optical properties, such as index of refraction, transmittance, reflectance, and absorbance; 2) smart properties, such as ferromagnetic properties, ferroelectric properties, nonlinear optical properties, electrical and/or thermal conductivity; 3) value of the material; and 4) constitutive properties thereof. Such properties depend on the choice of and amount of adherent, and the order of addition of the components.

The conformal coating process, in accordance with embodiments, has several advantages over conventional thin film deposition methods, such as vacuum evaporation, chemical vapor deposition and sputtering. It is cost effective because no special equipment is necessary, such as a high vacuum chamber. It is highly reproducible because the modifications are done in a stepwise fashion. Readily available materials or novel polymers, nano-particles and reagents, may yield the desired final product in an ambient lab setting.

A number of different metals may be adsorbed and reacted directly onto the fillers or substrates to generate a wide platform of properties and controlled conformal coating thickness. In general, the methodology of the invention may involve immersion of chemically functionalized filler into several solutions containing a metal and a reducing agent (further referred to as the seeding solution). The sequential growth of metal in the seeding solution may occur on substrates functionalized with metal nano-particles or an organic moiety that strongly adsorbs the metal in the seeding solution.

One specific embodiment may involve the sequential conformal coating of Au onto mica. Mica's natural sheen and luster make it an excellent choice for cosmetics and other special effects. Mica is safe on sensitive skin, non-carcinogenic, non-toxic and totally inert making it suitable for human applications. Mica also exhibits high UV stability, low abrasiveness, excellent lubricity, good skin adhesion, and resistance to heat, weather and a variety of chemicals. Cosmetic fillers based on mica block UV radiation and prevent skin cancer. Mica provides a smooth feel to powder in cosmetics and is more transparent than talc. Accordingly, the importance of building conformal coatings onto the irregular surface of mica in a sequential manner may be critical to maintain the beneficial properties described above, while adding value to the product.

A mica substrate or filler may be first functionalized with thiol groups as described above, and then immersed in an aqueous solution of Au nano-particles for a time period in the range of about 1 minute to about 300 minutes and in particular for about 60 minutes, until a dense monolayer of Au nano-particles is absorbed onto the surface. Alternatively, the thiol functionalized substrate may be immersed directly into the seeding solution which will result in a different effect. The thiol groups or primary layer of Au nano-particles may act as a nucleation sites for further Au growth as HAuCl₄ is reduced onto the surface (from the seeding solution). The thiol and gold coated fillers or substrates may yield different products with controlled properties after coating in the seeding solutions.

In one specific example the process was performed in the following manner. First, the thiol or gold modified filler was stirred in an aqueous solution of the reducing agent NH₂OH_HCl (i.e., the seeding solution). Then, an aqueous solution of HAuCl₄ was added and stirred until the Au was completely reduced. The filler or substrate may be immersed in either solution followed by the addition of the other. Organic groups other than thiols (e.g., phosphines, amines, or hydroxyls, and the like) with an affinity towards Au (or other metals) may also be used. The reduced Au deposits and grows on the nano-particle surfaces at a faster rate than new particles are nucleated resulting in the deposition of conductive films with controllable thickness instead of nucleation and growth of new particles in the aqueous solution. Using this process, film thickness and the resulting properties, such as conductivity and reflectance, for example, may be controlled by varying the starting material amounts, relative concentrations, and the immersion time. Typical thickness and resistivity values for electrodes prepared using this method are approximately 250 nm and 1.5 Ω/sq measured using a four-point-probe.

### EXAMPLE 1

### Au Conformal Coatings on Mica

This example coating procedure provides merely one example of specific chemicals, specific amounts and specific conditions for performing the conformal coating of a substrate. Other embodiments contemplate varying the conditions, chemicals, and amounts, and concentrations; thus, embodiments are not limited to the specific example procedure described below.

Mica was dehydrated, cleaned and chemically functionalized with 3-mercaptopropyltriethoxysilane. Cleaning was performed by dehydration, followed by sonication in 1M HNO₃ acid, water and ethanol for 15 minutes each. Thiol functionalization was performed by reacting the hydroxyl rich surface of the mica with 3-mercaptopropyltriethoxysilane in dry purified toluene. This process was done at various temperatures and times to yield different amounts of sulfur at the surface. Finally, siloxane bonds were formed at the surface via thermal curing in a vacuum oven at a temperature greater than about 100° C. for a time period greater than about 1 hour.

Various types of mica with varied percentages of thiol at the surface were prepared sequentially with varied immersions in Au nano-particles and seeding solutions. Monolayers of Au were formed on thiol functionalized mica by immersion into a gold solution (Au nano-particles stabilized by sodium citrate in ultra-pure water, about 18.3 M Ω-cm) for greater than about 1 minute and up to several days. In some cases, a rinse in ultra-pure water (18.3 MΩ-cm) may follow. Thickness of the conformal Au monolayer may be controlled by the size of the Au nano-particles in the Au solution. The conductivity and the optical transparency may be simultaneously manipulated (inversely related) through the thickness of the gold coating. If several nm thick bilayers of gold are desired, a second solution containing a dithiol (or other reagent with two Au attracting moieties) may be prepared and used to crosslink the Au monolayers. Shorter effective molecular chain lengths may yield higher electrical conductivity with lower optical transmittance through the film. When a thicker conformal film of Au is desired, either the thiol or Au monolayer functionalized mica may be immersed at least one time into the seeding solutions. Typically, about 0.15 g of mica may be stirred in about 150 ml of aqueous NH₂OH for a time period greater than 1 about minute. Then, about 150 ml of aqueous HAuCl₄ may be poured into the former solution. This mixture may begin as a pale yellow solution and as the Au reduces on the surface of the mica, the solution may become clear. Water may be removed via decanting or filtration. The coated mica may either be dried in a vacuum oven, or the process may be repeated until the desired thickness and properties have been achieved.

Thus, in accordance with embodiments, formation of conformal coatings is described wherein the coatings are on nano-particle, micro-particles and onto irregularly shaped substrates with an uneven surface. The coating properties are tailored via surface modifications with nano-species (e.g. metallic, ceramic, magnetic, polymeric, analgesic, etc.) and combinations thereof onto any substrate (metallic, ceramic, magnetic, polymeric, etc.). Such coatings display useful constitutive properties such as, for example, permittivity, permeability, electrical conductivity, thermal conductivity, and nonlinear optical properties determined by the type of nano-particle used to modify the elected substrate. In the example of gold coated mica, the result is a mica-based filler for paint or cosmetics that has the appearance and behavior of gold but is provided at a fraction of the cost and weight. This principle holds equally true for other precious metals such as silver, copper, platinum, palladium, and alloys thereof.

Particular properties imparted to substrates as a result of conformal coatings may include, but are not limited to, electrical conductivity, enhanced radiopacity, thermal conductivity, magnetic permeability and other magnetic properties, reflectance, absorption, permittivity, chemical affinity, biocompatibility, color, sheen, luster. The conformal coated substrates can be applied to any product that uses fillers (e.g., fiber, particulate, etc.). Using conformal coated fillers (instead of the bulk material) may decrease the cost of the composite material (e.g., paint, adhesive, cosmetics) and can provide a functional change to the filler, a cosmetic improvement to the filler, or both.

While many of the example applications described above relate to visual appearances of cosmetics and paints. Other applications may include incorporate nano-particle of desired characteristics to achieve or modify the transmission and reflection properties of paints (and thereby the material which is painted). Control of reflection and transmission properties in the visible, infrared and thermal wavelength ranges may be achieved. Additionally, incorporation of magnetic materials allows control of other physical attributes such as, for example, electromagnetic wave phase delay.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device comprising:
a substrate having an outer surface;
a nano-particle coating on the outer surface, said nano-particle coating being substantially a molecular monolayer of a plurality of nano-particles.

2. The device of claim 1, wherein the nano-particle coating substantially surrounds the outer surface.

3. The device of claim 1, wherein the outer surface includes one or more crevices which the nano-particle coating coats.

4. The device of claim 1, wherein the substrate comprises a filler material.

5. The device of claim 1, wherein the nano-particle coating comprises a precious metal.

6. The device of claim 1, wherein the substrate comprises mica.

7. The device of claim 1, wherein the substrate comprises a medical stent.

8. The device of claim 7, wherein the nano-particle coating increases radiopacity of the substrate.

9. A composite material comprising:
a base material including one or more ingredients; and
a filler material, said filler material comprising a plurality of particulates each comprising:
a substrate having an outer surface; and
a nano-particle coating on the outer surface.

10. The composite material of claim 9, wherein a thickness of the nano-particle coating is less than 1000 nm.

11. The composite material of claim 10, wherein the thickness is less than 50 nm.

12. The composite material of claim 9, said nano-particle coating comprises a substantially molecular monolayer of a plurality of nano-particles.

13. The composite material of claim 9, wherein the base material is one of a paint, an adhesive, and a cosmetic product.

14. The composite material of claim 9, wherein the nano-particle coating comprises a precious metal.

15. The composite material of claim 9, wherein the filler material is substantially evenly distributed within the composite material.

16. A method of formulating a composite material comprising:
combining a base material including one or more ingredients and a filler material; and
wherein said filler material comprises a plurality of particulates each comprising:
a substrate having an outer surface; and
a nano-particle coating on the outer surface.

17. The method of claim 16, wherein the composite material differs from the base material in at least one attribute selected from the group: electrical conductivity, enhanced radiopacity, thermal conductivity, magnetic permeability and other magnetic properties, reflectance, absorption, permittivity, chemical affinity, biocompatibility, color, sheen, and luster.

18. The method of claim 16, wherein said nano-particle coating comprises a substantially molecular monolayer of a plurality of nano-particles.

19. The method of claim 16, wherein the base material is intended to cover at least a portion of a surface of an object.

20. The method of claim 16, wherein the nano-particle coating comprises a precious metal.
